(19) United States
(12) Patent Application Publication
(10) Pub. No.: US 2016/0134975 A1
(43) Pub. Date: May 12, 2016

(54) Microphone With Trimming

(71) Applicant: Knowles Electronics, LLC, Itasca, IL (US)

(72) Inventors: Michael Kuntzman, Chicago, IL (US); John Albers, Chicago, IL (US); Claus Fürst, Roskilde (DK)

(21) Appl. No.: 14/926,875

(22) Filed: Oct. 29, 2015

Related U.S. Application Data
(60) Provisional application No. 62/237,165, filed on Oct. 5, 2015.
(60) Provisional application No. 62/078,624, filed on Nov. 12, 2014.

(51) Int. Cl. H04R 19/04; H04R 29/00; H04R 3/06

(52) U.S. Cl. CPC H04R 19/04; H04R 3/06; H04R 29/004; H04R 2201/003

(57) ABSTRACT

A microphone includes a microelectromechanical system (MEMS) device, an amplifier, and an attenuation apparatus. The MEMS device converts acoustic energy into electrical signals. The amplifier is coupled to the MEMS device and receives an input signal from the MEMS device and performs amplification on the input signal to produce an output signal. The attenuation apparatus is coupled to the amplifier. Activation of the attenuation apparatus is effective to attenuate the output signal of the amplifier. A self-noise of the amplifier is attenuated and a sensitivity of the microphone is reduced such that a first signal-to-noise ratio is substantially the same as a second signal-to-noise ratio. The first signal-to-noise ratio occurs when the attenuation apparatus is not activated, and the second signal-to-noise ratio occurs when the attenuation apparatus is activated.

### CROSS-REFERENCE TO RELATED APPLICATION

This patent claims benefit under 35 U.S.C. §119(e) to U.S. Provisional Application No. 62/078,624 entitled “Microphone with Trimming” filed Nov. 12, 2014, and also claims benefit to U.S. Provisional Application 62/237,165 entitled “Microphone with Trimming” filed Oct. 5, 2015 the contents of both of which are incorporated herein by reference in their entireties.

### TECHNICAL FIELD

This application relates to microphones and the operation and performance of these microphones.

### BACKGROUND OF THE INVENTION

Microphones are used to obtain sound energy and convert the sound energy into electrical signals. Once obtained, the electrical signals can be processed in a number of different ways.

One example of a microphone is a Micro-Electro-Mechanical System (MEMS) microphone. MEMS microphones are typically composed of two main components: a MEMS device (including a diaphragm and a back plate) that receives and converts sound energy into an electrical signal, and an Application Specific Integrated Circuit (ASIC) (or other circuits such as buffers, amplifiers, and analog-to-digital converters). The ASIC receives the electrical signal from the MEMS device and performs post-processing on the signal and/or buffering the signal for the following circuit stages. The following circuit stages may include a codec or digital signal processor (DSP) to mention two examples.

The MEMS component is typically desired to have a higher output than a customer's DSP or codec requires. Consequently, the sensitivity (i.e., the ratio of voltage output to incoming sound pressure) of the microphone is reduced.

In previous approaches, microphone noise sensitivity was sometimes reduced, but at the cost of decreasing the signal-to-noise ratio of the microphone. The drawbacks associated with previous approaches have resulted in some general user dissatisfaction.

### BRIEF DESCRIPTION OF THE DRAWINGS

For a more complete understanding of the disclosure, reference should be made to the following detailed description and accompanying drawings wherein:

FIG. 1 comprises a block diagram of a microphone according to various embodiments of the present invention;

FIG. 2 comprises a block diagram of a microphone according to various embodiments of the present invention;

FIG. 3 comprises a block diagram of a microphone according to various embodiments of the present invention;

FIG. 4 comprises a block diagram of a microphone according to various embodiments of the present invention;

FIG. 5 comprises a block diagram of a microphone according to various embodiments of the present invention;

FIG. 6 comprises two graphs showing some of the advantages of the present approaches according to various embodiments of the present invention;

FIG. 7 comprises a block diagram of a microphone according to various embodiments of the present invention;

FIG. 8 comprises a block diagram of a microphone according to various embodiments of the present invention;

FIG. 9 comprises a block diagram of a microphone according to various embodiments of the present invention;

FIG. 10 comprises a block diagram of a microphone according to various embodiments of the present invention;

FIG. 11 comprises a block diagram of a microphone according to various embodiments of the present invention;

FIG. 12 comprises a block diagram of a microphone according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide microphones where the sensitivity of the microphone is adjusted (e.g., trimmed), but the signal-to-noise ratio (SNR) of the microphone is not reduced (or not substantially reduced). These advantages are accomplished in one aspect by disposing one or more attenuation components (e.g., resistors, capacitors, or active components) at the output of the microphone. In addition to disposing attenuation components at the output of the microphone, attenuation components may be placed at the input of the microphone.

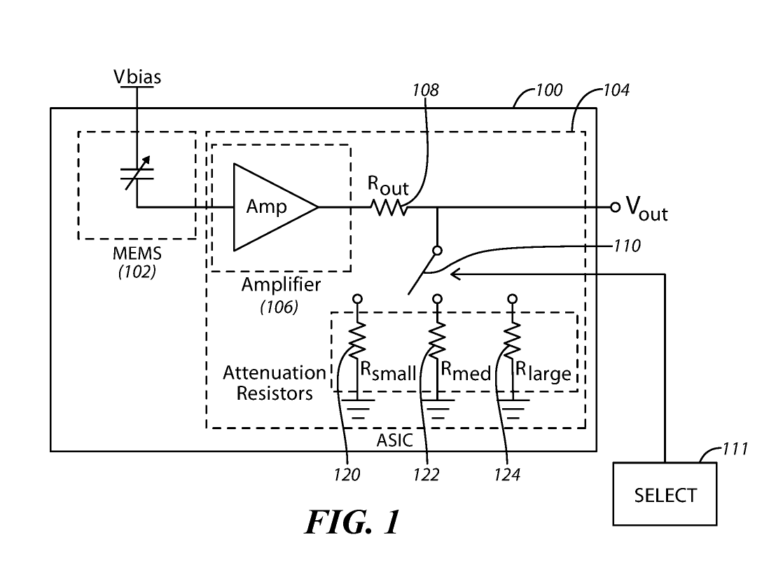

Referring now to FIG. 1, one example of a microphone 100 that is coupled to a customer electronic device is described. The microphone 100 includes a MEMS device 102 and an application specific integrated circuit (ASIC) 104. The MEMS device 102 (or in some cases other sensing elements such as a piezoelectric sensor) converts sound energy into an electrical signal, which is sent to the ASIC 104. In one example, the MEMS device 102 includes a diaphragm and back plate. In other examples, other devices (e.g., piezoelectric sensors) may be used that do not include a diaphragm and back plate.

The ASIC 104 may be any type of integrated circuit that includes an amplifier 106 (e.g., with an op-amp having a gain) or impedance buffer. The ASIC 104 also includes an output resistor 108 (Rₒᵤₜ).

In addition, the ASIC 104 includes a bank of attenuation resistors: a small value resistor 120, a medium value resistor 122, and a large value resistor 124. In one aspect, the values of the resistors are sufficiently small so as to add relatively little noise to the microphone 100. A switch 110 is used to selectively switch in appropriate resistors 120, 122, and 124 to the microphone circuit. This may be accomplished by a user selection 111, which in one example is manually performed, but in some cases may be automatically performed. The number and value of resistors to be added to the circuit depend upon the amount of attenuation needed by a customer device (e.g., a codec or DSP of a customer) that is coupled to Vₒᵤₜ. Consequently, although the switch 110 is shown as being open in this and the other figures herein, it will be appreciated that, in fact, it will couple to one or more of the resistors 120, 122, and 124. Together, whichever resistors 120, 122, and 124 are selected, the selected resistors form an equivalent resistance Rₐₜₜₑₙ that is coupled to Vₒᵤₜ.

In this case, Vₒᵤₜ=(Rₐₜₜₑₙ/(Rₒᵤₜ+Rₐₜₜₑₙ)) V_{signal}, where Rotten is the equivalent value of the resistors 120, 122, and 124 selected by switch 110, and V_{signal} is the voltage of the signal received from the MEMS device 102. The resistors 120, 122, and 124 are disposed at the output of the amplifier 106 to perform attenuation. In this case, the amplifier noise is attenuated, so the original SNR of the microphone is preserved even after one or more of the resistors 120, 122, and 124 are added to the ASIC 104. Again, the exact value of Rₐₜₜₑₙ will vary, depending upon the resistors selected and the values of these resistors. Moreover, although three possible resistors 120, 122, and 124 are shown, it will be appreciated that any number of resistors may be used depending on the trim resolution and range desired by the designer. It should also be noted that in some instances, it may be advantageous to add a buffer at the output of the circuit to prevent the trimming network from effecting the output impedance of the microphone as seen by any following circuitry (e.g. a codec, a DSP, to mention two examples)

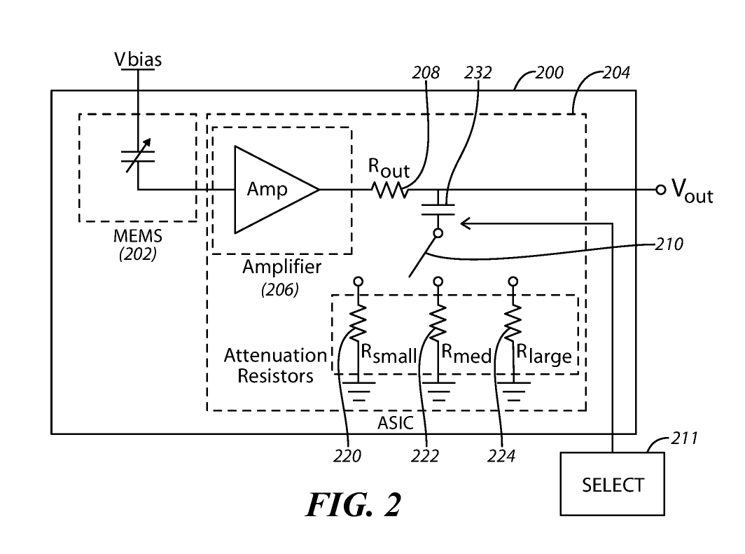

Referring now to FIG. 2, another example of a microphone 200 that is coupled to customer electronics is described. The microphone 200 includes a MEMS device 202 and an application specific integrated circuit (ASIC) 204. The MEMS device 202 (or in some cases other sensing elements such as a piezoelectric sensor) converts sound energy into an electrical signal, which is sent to the ASIC 204. In one example, the MEMS device 202 includes a diaphragm and back plate. In other examples, other devices (e.g., piezoelectric sensors) may be used that do not include a diaphragm and back plate.

The ASIC 204 may be any type of integrated circuit that includes an amplifier 206 (e.g., with an op-amp having a gain) or impedance buffer. The ASIC 204 also includes an output resistor 208 (Rₒᵤₜ).

In addition, the ASIC 104 includes a bank of attenuation resistors: a small value resistor 220, a medium value resistor 222, and a large value resistor 224. In one aspect, the values of the resistors 220, 222, and 224 are sufficiently small so as to add negligible noise to the microphone. A switch 210 is used to switch in appropriate resistors 220, 222, and 224 to the circuit. This may be accomplished by a user selection 211, which in one example is manually performed, but in some cases may be automatically performed. The number of resistors to be added to the circuit depend upon the amount of attenuation needed by a customer device (e.g., a codec or DSP of a customer) that is coupled to Vₒᵤₜ. Consequently, although the switch 210 is shown as being open in this and the other figures herein, it will be appreciated that in fact it will couple to one or more of the resistors 220, 222, and 224. Together, whichever resistors 220, 222, and 224 are selected, the selected resistors form an equivalent resistance Rₐₜₜₑₙ that is coupled to Vₒᵤₜ.

In this case, Vₒᵤₜ=(Rₐₜₜₑₙ/(Rₒᵤₜ+Rₐₜₜₑₙ)) V_{signal}, where Rₐₜₜₑₙ is the equivalent value of the resistors 220, 222, and 224 selected by switch 210, and V_{signal} is the voltage of the signal received from the MEMS device 202. The resistors 220, 222, and 224 are disposed at the output of the amplifier 206 to perform attenuation. In this case, the amplifier noise is attenuated, so the original SNR of the microphone is preserved even after one or more of the resistors 220, 222, and 224 are added to the ASIC 204. Again, the exact value of Rₐₜₜₑₙ will vary, depending upon the resistors selected and the values of these resistors. Moreover, although three possible resistors 220, 222, and 224 are shown, it will be appreciated that any number of resistors may be used. It should also be noted that in some instances, it may be advantageous to add a buffer at the output of the circuit to prevent the trimming network from effecting the output impedance of the microphone as seen by any following circuitry (e.g. codec, DSP, to mention two examples).

A capacitor 232 is coupled in series with the switch 210. The capacitor 232 prevents DC current flow through resistors 220, 222, and 224. In some aspects, the capacitor 232 has a value such to define a cutoff frequency of f_{hpf}=1/(2*pi*C*Rₐₜₜₑₙ), where signal attenuation occurs only above the cutoff frequency.

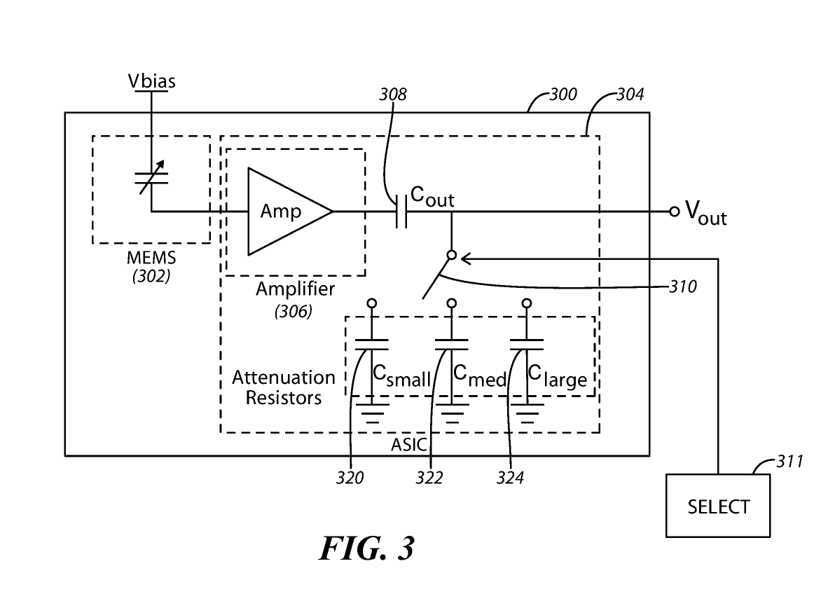

Referring now to FIG. 3, another example of a microphone 300 that is coupled to customer electronics is described. The microphone 300 includes a MEMS device 302 and an application specific integrated circuit (ASIC) 304. The MEMS device 302 (or in some cases other sensing elements such as a piezoelectric sensor) converts sound energy into an electrical signal, which is sent to the ASIC 304. In one example, the MEMS device 302 includes a diaphragm and back plate. In other examples, other devices (e.g., piezoelectric sensors) may be used that do not include a diaphragm and back plate.

The ASIC 304 may be any type of integrated circuit that includes an amplifier 306 (e.g., with an op-amp having a gain) or impedance buffer. The ASIC 304 also includes an output capacitor 308 (Cₒᵤₜ).

In addition, the ASIC 304 includes a bank of attenuation capacitors: a small value capacitor 320, a medium value capacitor 322, and a large value capacitor 324. In one aspect, the values of the capacitors have values selected so as to add negligible noise to the microphone 300. A switch 310 is used to switch in appropriate capacitors 320, 322, and 324 to the circuit. This may be accomplished by a user selection 311, which in one example is manually performed, but in some cases may be automatically performed. The capacitors to be added to the circuit depend upon the amount of attenuation needed by a customer device (e.g., a codec or DSP of a customer) that is coupled to Vₒᵤₜ. Consequently, although the switch 310 is shown as being open in this and the other figures herein, it will be appreciated that in fact it will couple to one or more of the capacitors 320, 322, and 324. Together, whichever capacitors 320, 322, and 324 are selected, the selected capacitors form an equivalent capacitance Cₐₜₜₑₙ that is coupled to Vₒᵤₜ.

In this case, Vₒᵤₜ=(Cₒᵤₜ/(Cₒᵤₜ+Cₐₜₜₑₙ)) V_{signal}, where Cₐₜₜₑₙ is the equivalent value of the capacitance 320, 322, and 324, and V_{signal} is the voltage of the signal received from the MEMS device 302. The number and value of capacitors are used at the output of the amplifier 306 to perform attenuation depend on the level of attenuation desired. In this case, the amplifier noise is attenuated, so the original SNR of the microphone is preserved even after one or more of the capacitance 320, 322, and 324 are added to the ASIC 304. Again, the exact value of Cₐₜₜₑₙ will vary, depending upon the capacitors selected and the values of these capacitors. Moreover, although three possible capacitors 320, 322, and 324 are shown, it will be appreciated that any number of capacitors may be used. It should also be noted that in some instances, it may be advantageous to add a buffer at the output of the circuit to prevent the trimming network from effecting the output impedance of the microphone as seen by any following circuitry (e.g. codec, DSP, to mention two examples).

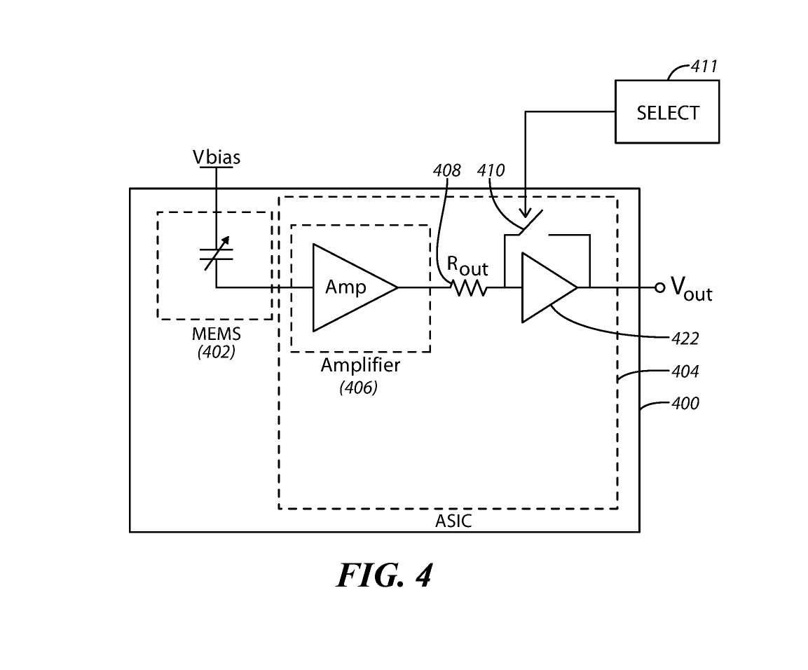

Referring now to FIG. 4, another example of a microphone 400 that is coupled to customer electronics is described. The microphone 400 includes a MEMS device 402 and an application specific integrated circuit (ASIC) 404. The MEMS device 402 (or in some cases other sensing elements such as a piezoelectric sensor) converts sound energy into an electrical signal, which is sent to the ASIC 404. In one example, the MEMS device 402 includes a diaphragm and back plate. In other examples, other devices (e.g., piezoelectric sensors) may be used that do not include a diaphragm and back plate.

The ASIC 404 may be any type of integrated circuit that includes an amplifier 406 (e.g., with an op-amp having a gain) or impedance buffer. The ASIC 404 also includes an output resistor 408 (Rₒᵤₜ).

In addition, the ASIC 404 includes an active attenuation circuit 422 that includes which has variable gain settings which can be selected by a switch 410. This may be accomplished by a user selection 411, which in one example is manually performed, but in some cases may be automatically performed. Consequently, although the switch 410 is shown as being open in this and the other figures herein, it will be appreciated that in fact it will couple to one or more active elements within active attenuation circuit 422. Together, whichever active attenuation elements are selected, the selected elements form an equivalent less than unity gain, Aᵥ, that is coupled to Vₒᵤₜ.

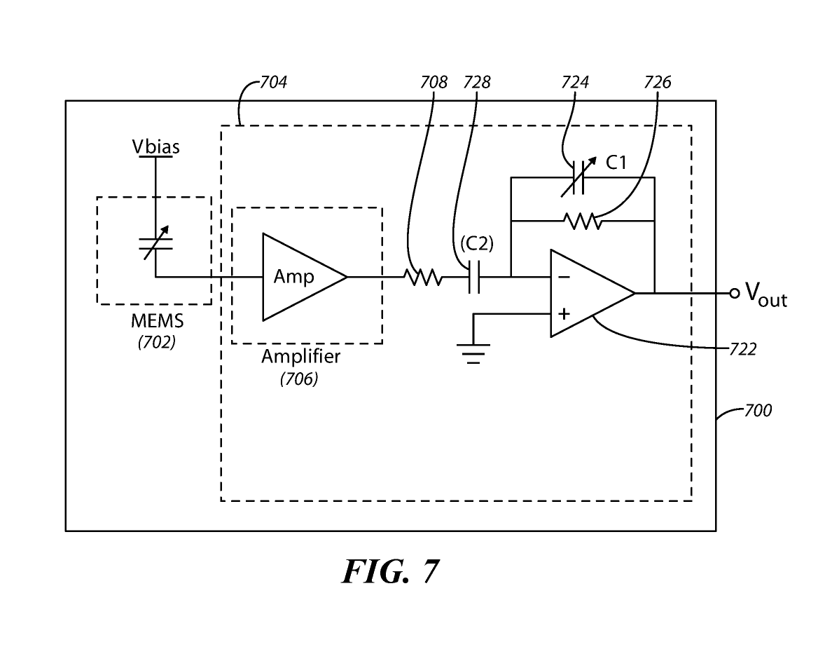

In this case, Vₒᵤₜ=Aᵥ*V_{signal}, where Aᵥ is the equivalent gain of the active attenuation circuit 422, and V_{signal} is the voltage of the signal received from the MEMS device 402. The active attenuation circuit 422 is used at the output of the amplifier 406 to perform attenuation. In this case, the amplifier noise is attenuated, so the original SNR of the microphone is preserved even after the active attenuation circuit 422 added to the ASIC 404. Again, the exact value of Av will vary, depending upon the resistors selected and the values of these resistors. A skilled artisan will appreciate that there are many ways to implement the less-than-unity gain circuit in practice. Several examples of which will be illustrated in FIGS. 7-10.

It will be appreciated that the examples of FIGS. 1-4 and 7-11 present approaches of trimming the sensitivity of a microphone in ways which preserve the SNR of the sensor by moving the trimming to occur after the sensor buffering or amplification in the signal chain. This approach is referred to as “back-end trimming” and refers to sensitivity trimming, which is performed after the signal has been passed through the input stage of the amplifier or buffer circuitry.

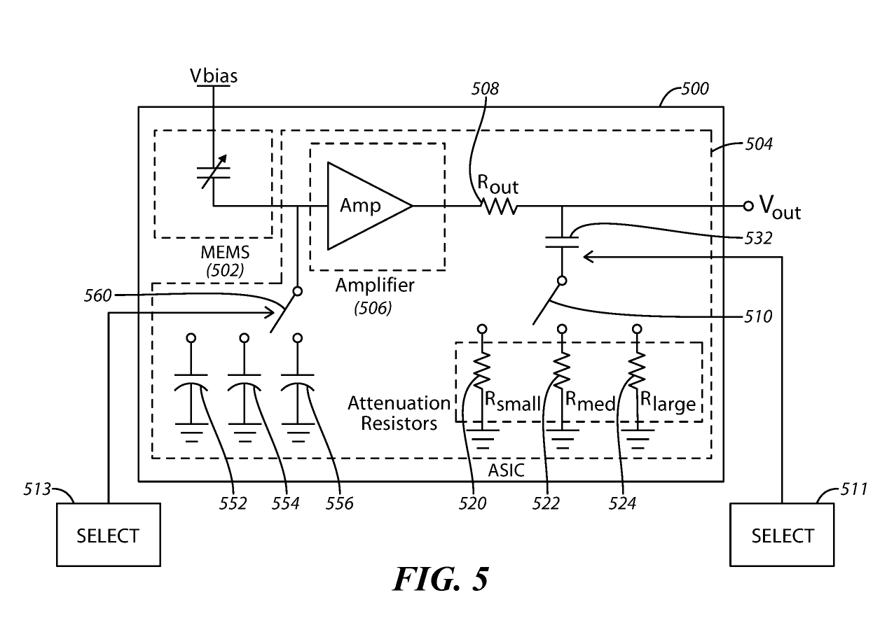

In other approaches, sensitivity trimming is implemented prior to the first stage of the buffer or amplifier circuit and performed after the signal has been passed through the input stage of the amplifier or buffer circuits. Referring now to FIG. 5, another example of a microphone 500 that is coupled to customer electronics is described. The microphone 500 includes a MEMS device 502 and an application specific integrated circuit (ASIC) 504. The MEMS device 502 (or in some cases other sensing elements such as a piezoelectric sensor) converts sound energy into an electrical signal, which is sent to the ASIC 504. In one example, the MEMS device 502 includes a diaphragm and back plate. In other examples, other devices (e.g., piezoelectric sensors) may be used that do not include a diaphragm and back plate.

The ASIC 504 may be any type of integrated circuit that includes an amplifier 206 (e.g., with an op-amp having a gain) or impedance buffer. The ASIC 504 also includes an output resistor 508 (Rₒᵤₜ).

In addition, the ASIC 504 includes a bank of attenuation resistors: a small value resistor 520, a medium value resistor 522, and a large value resistor 524. In one aspect, the values of the resistors are sufficiently small so as to add relatively little noise to the microphone 500. A switch 510 is used to switch in appropriate resistors 520, 522, and 524 to the circuit. The setting of the switch 510 may be accomplished by a user selection 511, which in one example is manually performed, but in some cases may be automatically performed. The number and resistance values of resistors to be added to the circuit depend upon the amount of attenuation needed by a customer device (e.g., a codec or DSP of a customer) that is coupled to Vₒᵤₜ. Consequently, although the switch 510 is shown as being open in this and the other figures herein, it will be appreciated that in fact it will couple to one or more of the resistors 520, 522, and 524. Together, whichever resistors 520, 522, and 524 are selected, the selected resistors form an equivalent resistance Rₐₜₜₑₙ that is coupled to Vₒᵤₜ.

In this case, Vₒᵤₜ=(Rₐₜₜₑₙ/(Rₒᵤₜ+Rₐₜₜₑₙ))V_{signal}, where Rₐₜₜₑₙ is the equivalent value of the resistors 520, 522, and 524, and V_{signal} is the voltage of the signal received from the MEMS device 502. The resistors are used at the output of the amplifier 506 to perform attenuation. In this case, the amplifier noise is attenuated, so the original SNR of the microphone is preserved even after one or more of the resistors 520, 522, and 524 are added to the ASIC 504. Again, the exact value of Rₐₜₜₑₙ will vary, depending upon the resistors selected and the values of these resistors. Moreover, although three possible resistors 520, 522, and 524 are shown, it will be appreciated that any number of resistors may be used.

A capacitor 532 is coupled in series with the switch 510. The capacitor 532 prevents current flow through resistors 520, 522, and 524. In some aspects, the capacitor 532 has a value such the F_{hpf}=1/(2*pi*C*Rₐₜₜₑₙ).

A capacitor bank is also provided at the input of the amplifier. This capacitor bank includes a small capacitor 552, a medium capacitor 554, and a large capacitor 556. A switch 560 is set to selectively switch in selected ones of the capacitors 552, 554, and 556. This may be accomplished by a user selection 513, which in one example is manually performed, but in some cases may be automatically performed. Consequently, although the switch 560 is shown as being open in this and the other figures herein, it will be appreciated that in fact it will couple to one or more of the capacitors 552, 554, and 556. The use of the capacitors 552, 554, and 556 controls microphone distortion (improves total harmonic distortion (THD)), while the use of resistors 520, 522, and 524 maintains or improves the SNR of the microphone. Moreover, although three possible resistors 520, 522, and 524 and three possible capacitors 552, 554, and 556 are shown, it will be appreciated that any number of resistors and capacitors may be used.

While FIG. 5. shows how a bank of selectable input capacitors can be combined with a selectable back of attenuation resistors after the input buffer to optimize a trade-off between SNR and THD, a user will appreciate that any of the back-end attenuation methods illustrated in FIGS. 1-4 and FIGS. 7-11 can be combined with a selectable bank of input capacitors to similar effect.

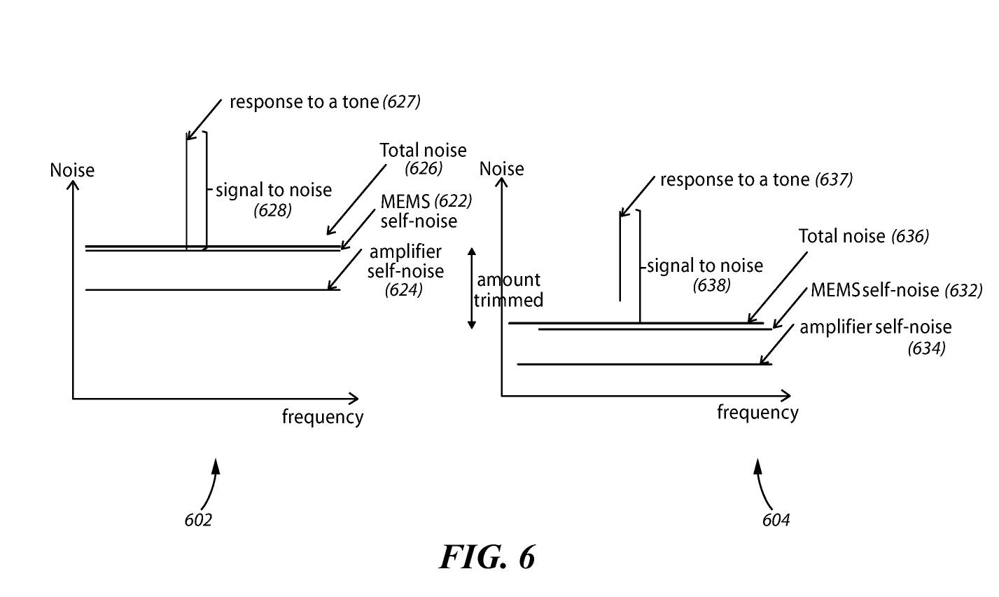

Referring now to FIG. 6, some of the advantages of the present approaches are described. A first graph 602 shows various characteristics of a microphone before attenuation is performed. A second graph 604 shows the effects of performing the present approaches at a microphone.

The first graph 602 shows MEMS self-noise 622, amplifier self-noise 624, total noise 626 a response to tone 627, and signal to noise ratio (SNR) 628. Before attenuation, the MEMS self-noise is shown here as being above the amplifier self-noise, as is often the case, and the SNR is at its maximum value.

The second graph 604 shows MEMS self-noise 632, amplifier self-noise 634, total noise 636 a response to tone 637, and signal to noise ratio (SNR) 638. After attenuation is performed, the MEMS self-noise 632 is reduced (from original MEMS self-noise 622) and the sensitivity (Vₒᵤₜ/sound pressure) of the microphone is reduced. The amplifier self-noise 634 is also reduced (in comparison to previous approaches where it was not reduced). As a result, the SNR 638 is the same as (or approximately the same as) the SNR 628. Therefore, a microphone is provided where sensitivity can be adjusted through attenuation of its output signal but without degradation of the SNR of the microphone.

Referring now to FIG. 7, another example of a microphone 700 that is coupled to customer electronics is described. The microphone 700 includes a MEMS device 702 and an application specific integrated circuit (ASIC) 704. The MEMS device 702 (or in some cases other sensing elements such as a piezoelectric sensor) converts sound energy into an electrical signal, which is sent to the ASIC 704. In one example, the MEMS device 702 includes a diaphragm and back plate. In other examples, other devices (e.g., piezoelectric sensors) may be used that do not include a diaphragm and back plate.

The ASIC 704 may be any type of integrated circuit that includes a first amplifier 706 (e.g., with an op-amp having a gain) or impedance buffer. The ASIC 704 also includes an output resistor 708 (Rₒᵤₜ).

In addition, the ASIC 704 includes a second operational amplifier 722, a first capacitor (C1) 724, a resistor 726, and a second capacitor (C2) 728. The first capacitor 724 may be a variable capacitor whose value is set during manufacturing or by either user input or automatically similar to the cases in FIGS. 1-4. The resistor 726 is large (e.g. 1 G ohm) and keeps output from becoming unstable. In this case, Vₒᵤₜ=(−C2/C1)*V_{signal}. It will be appreciated that this circuit functions as a charge amplifier. While a capacitor 724 is drawn as a single, variable capacitor, it should be appreciated that capacitor 724 could be replaced with a bank of selectable capacitors to similar effect. It should also be appreciated that capacitor 728 could be made variable rather than or in addition to capacitor 724, either by means of a single variable capacitor or a bank of selectable capacitors. It should also be noted that in some instances, it may be advantageous to add a buffer at the output of the circuit to prevent the trimming network from effecting the output impedance of the microphone as seen by any following circuitry (e.g. codec, DSP, to mention two examples).

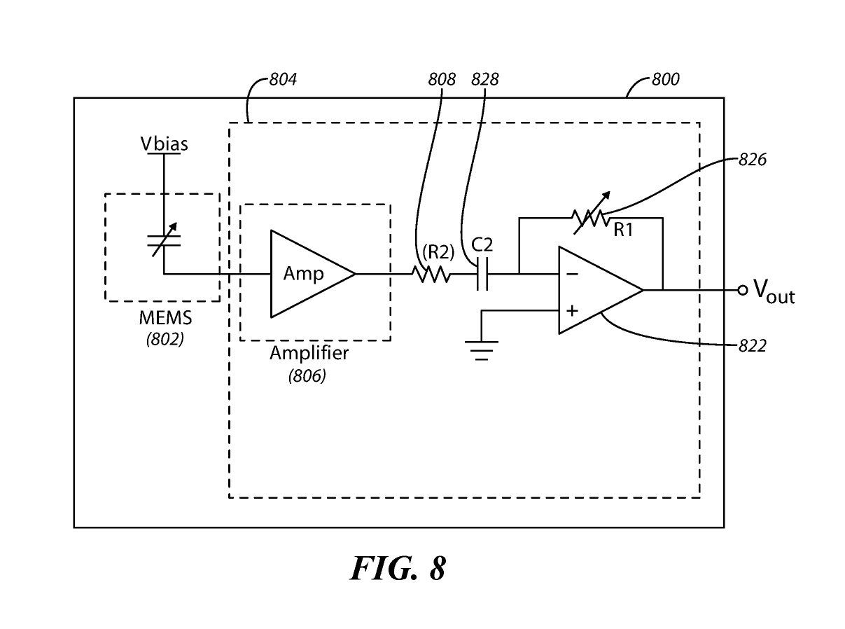

Referring now to FIG. 8, another example of a microphone 800 that is coupled to customer electronics is described. The microphone 800 includes a MEMS device 802 and an application specific integrated circuit (ASIC) 804. The MEMS device 802 (or in some cases other sensing elements such as a piezoelectric sensor) converts sound energy into an electrical signal, which is sent to the ASIC 804. In one example, the MEMS device 802 includes a diaphragm and back plate. In other examples, other devices (e.g., piezoelectric sensors) may be used that do not include a diaphragm and back plate.

The ASIC 804 may be any type of integrated circuit that includes a first amplifier 806 (e.g., with an op-amp having a gain) or impedance buffer. The ASIC 804 also includes a variable output resistor 808 (R2).

In addition, the ASIC 804 includes a second operational amplifier 822, a first capacitor (C1) 824, a variable resistor 826 (R1), and a second capacitor (C2) 828. The value of the variable resistor 826 may be set during manufacturing or by either user input or automatically similar to the cases in FIGS. 1-4. The resistor 826 is small (e.g. 1 k ohm) and keeps output from becoming unstable. Capacitor 828 is included to provide rejection of any DC offset present at the output of amplifier or buffer 806. Capacitor 828 may be omitted in some cases, or if included, is selected such to provide DC rejection without interfering with the desired frequency response of the sensor. In this case, Vₒᵤₜ=(−R1/R2)*V_{signal}. This circuit functions as an inverting amplifier. While R1 is drawn as a single, variable resistor, it should be appreciated that resistor 826 could be replaced with a bank of selectable resistors to similar effect. It should also be appreciated that resistor 808 could be made variable rather than or in addition to resistor 826, either by means of a single variable resistor or a bank of selectable resistors. It should also be noted that in some instances, it may be advantageous to add a buffer at the output of the circuit to prevent the trimming network from effecting the output impedance of the microphone as seen by any following circuitry (e.g. codec, DSP, to mention two examples).

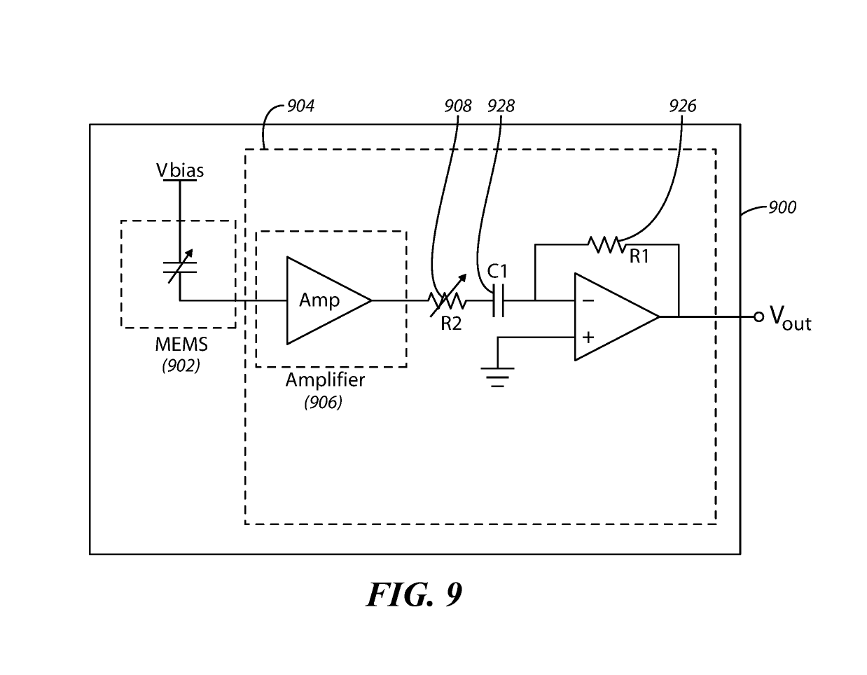

Referring now to FIG. 9, another example of a microphone 900 that is coupled to customer electronics is described. The microphone 900 includes a MEMS device 902 and an application specific integrated circuit (ASIC) 904. The MEMS device 902 (or in some cases other sensing elements such as a piezoelectric sensor) converts sound energy into an electrical signal, which is sent to the ASIC 904. In one example, the MEMS device 902 includes a diaphragm and back plate. In other examples, other devices (e.g., piezoelectric sensors) may be used that do not include a diaphragm and back plate.

The ASIC 904 may be any type of integrated circuit that includes a first amplifier 906 (e.g., with an op-amp having a gain). The ASIC 904 also includes a variable output resistor 908 (R2).

In addition, the ASIC 904 includes a second operational amplifier 922, a resistor 926 (R1), and a capacitor (C1) 928. The variable resistors 908 may be a variable resistor whose value is set during manufacturing. The resistor 926 is small (e.g. 1 k ohm) and keeps output from becoming unstable. The value of capacitor 928 (C1) is typically approximately 1 μF, but will vary by design and may be excluded in some instances. In this case, Vₒᵤₜ=(−R1/R2)*V_{signal}. It will be appreciated that this circuit functions as an inverting amplifier. It should also be noted that in some instances, it may be advantageous to add a buffer at the output of the circuit to prevent the trimming network from effecting the output impedance of the microphone as seen by any following circuitry (e.g. codec, DSP, etc.)

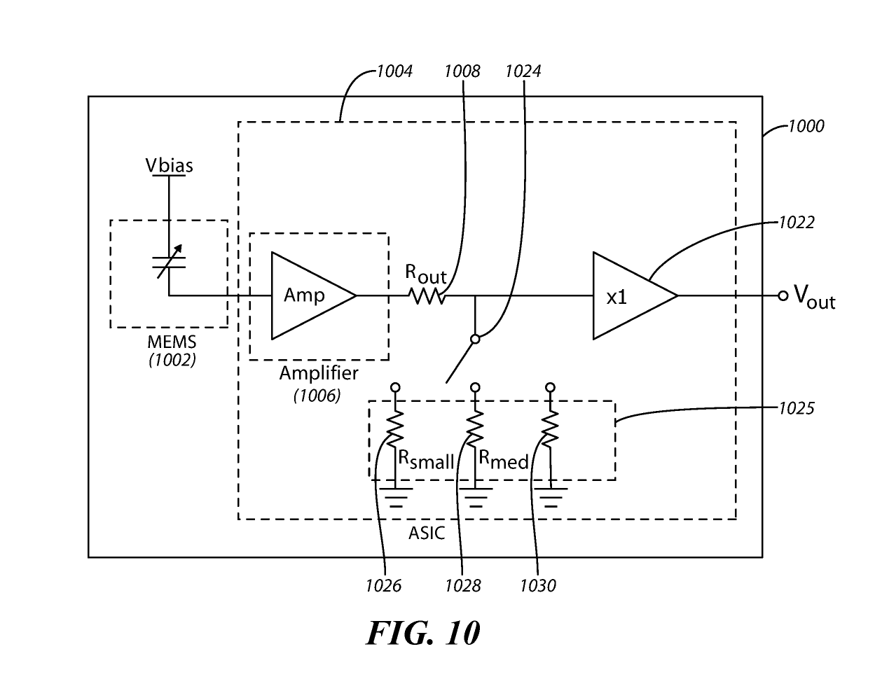

Referring now to FIG. 10, another example of a microphone 1000 that is coupled to customer electronics is described. The microphone 1000 includes a MEMS device 1002 and an application specific integrated circuit (ASIC) 1004. The MEMS device 1002 (or in some cases other sensing elements such as a piezoelectric sensor) converts sound energy into an electrical signal, which is sent to the ASIC 1004. In one example, the MEMS device 1002 includes a diaphragm and back plate. In other examples, other devices (e.g., piezoelectric sensors) may be used that do not include a diaphragm and back plate.

The ASIC 1004 may be any type of integrated circuit that includes a first amplifier 1006 (e.g., with an op-amp having a gain) or impedance buffer. The ASIC 1004 also includes an output resistor 1008 (Rₒᵤₜ).

In addition, the ASIC 1004 includes a second operational amplifier 1022. The ASIC 1004 includes a switch 1024 that selects between one or more of three resistors 1026, 1028, 1030 in a resistor bank 1025. In this case, Vₒᵤₜ=(Rₐₜₜₑₙ/(Rₒᵤₜ+Rotten)) V_{signal}, where Rotten is the equivalent value of the resistors 1026, 1028, 1030 selected by switch 1024, and V_{signal} is the voltage of the signal received from the MEMS device 1002. The range of resistor values selected will depend on the requirements of the designer, but in typical applications might range from 10's of ohms to 10's of kohms, although this range may not be inclusive of the preferred values for all designs. This circuit functions as a resistance trimming before a unity buffer. The resistor bank allows better control of the output impedance of the microphone

The resistors are used at the output of the amplifier 1006 to perform attenuation. In this case, the amplifier noise is attenuated, so the original SNR of the microphone is preserved even after one or more of the resistors 1026, 1028, and 1030 are added to the ASIC 1004. Again, the exact value of the attenuation resistance (Rₐₜₜₑₙ) will vary, depending upon the resistors selected and the values of these resistors. Moreover, although three possible resistors 1026, 1028, and 1030 are shown, it will be appreciated that any number of resistors may be used.

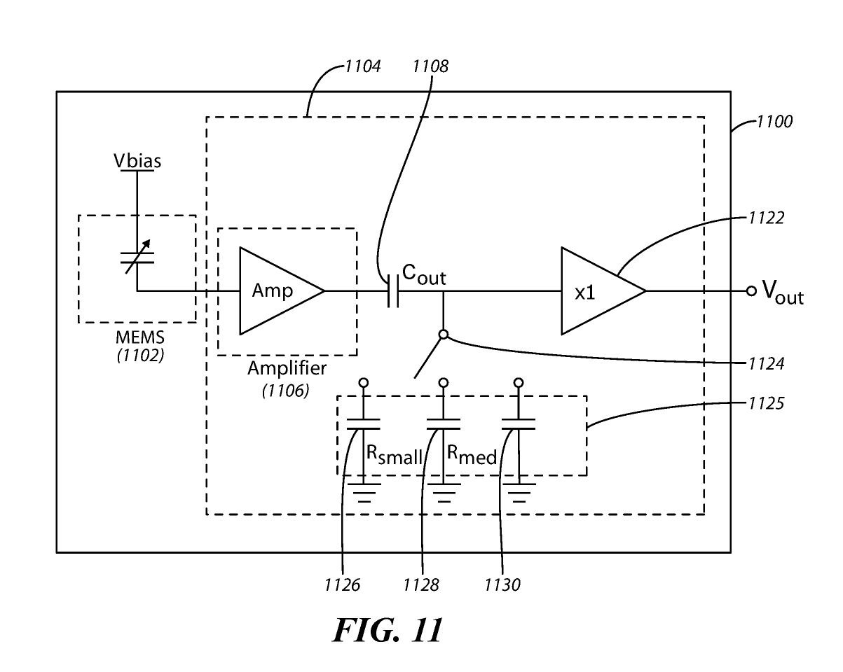

Referring now to FIG. 11, another example of a microphone 1100 that is coupled to customer electronics is described. The microphone 1100 includes a MEMS device 1102 and an application specific integrated circuit (ASIC) 1104. The MEMS device 1102 (or in some cases other sensing elements such as a piezoelectric sensor) converts sound energy into an electrical signal, which is sent to the ASIC 1104. In one example, the MEMS device 1102 includes a diaphragm and back plate. In other examples, other devices (e.g., piezoelectric sensors) may be used that do not include a diaphragm and back plate.

The ASIC 1104 may be any type of integrated circuit that includes a first amplifier 1106 (e.g., with an op-amp having a gain) or impedance buffer. The ASIC 1104 also includes an output capacitor 1108 (Cout).

In addition, the ASIC 1104 includes a second operational amplifier 1122. The ASIC 1104 includes a switch 1124 that selects between one of three capacitors 1126, 1128, 1130 in a capacitor bank 1125. Capacitor 1126 may be of a small value (e.g., 0.5 pF), resistor 1128 may be of medium value (e.g., 1 pF) and Capacitor 1130 may be of large value (e.g., 10 pF). In this case, Vₒᵤₜ=Cout/(Cout+Cattten)*V_{signal}. This circuit functions as a capacitor trimming before a unity buffer. The capacitor bank allows better control of the output impedance of the microphone.

The capacitors are used at the output of the amplifier 1106 to perform attenuation. In this case, the amplifier noise is attenuated, so the original SNR of the microphone is preserved even after one or more of the capacitors 1126, 1128, and 1130 are added to the ASIC 1104. Again, the exact value of the attenuation capacitance (Cₐₜₜₑₙ) will vary, depending upon the capacitors selected and the values of these capacitors. Moreover, although three possible capacitors 1126, 1128, and 1130 are shown, it will be appreciated that any number of capacitors may be used.

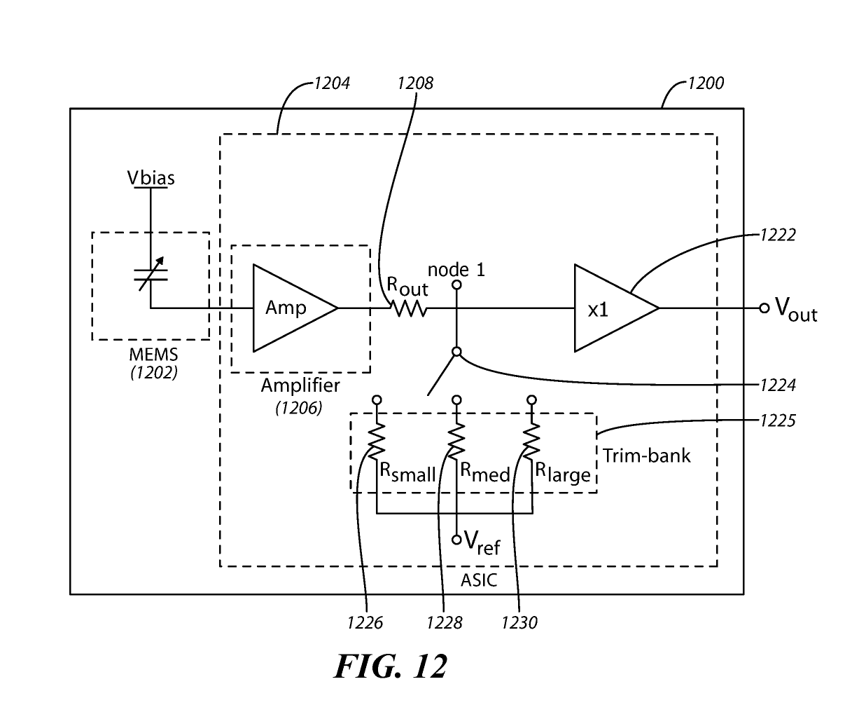

Referring now to FIG. 12, another example of a microphone 1200 is described. The microphone 1200 includes a MEMS device 1202 and an application specific integrated circuit (ASIC) 1204. The MEMS device 1202 (or in some cases other sensing elements such as a piezoelectric sensor) converts sound energy into an electrical signal, which is sent to the ASIC 1204. In one example, the MEMS device 1202 includes a diaphragm and back plate. In other examples, other devices (e.g., piezoelectric sensors) may be used that do not include a diaphragm and back plate.

The ASIC 1204 may be any type of integrated circuit that includes a first amplifier 1206 (e.g., with an op-amp having a gain) or impedance buffer. The ASIC 1204 also includes an output resistor 1208 (Rₒᵤₜ).

In addition, the ASIC 1204 includes a second operational amplifier 1222. The ASIC 1204 includes a switch 1224 that selects between one or more of three resistors 1226, 1228, 1230 in a resistor bank 1225.

This example is similar to the example that depicted in FIG. 10, except in this case, the resistors in bank 1225 are connected to a reference voltage rather than ground. The reference voltage can be set to any value, including ground. In an ideal case, the reference voltage will be set to match the DC level at the node labeled node 1. By matching Vref to node 1, DC current flow through the resistor(s) defining Rₐₜₜₑₙ is eliminated, while signal attenuation is still achieved by an apparent AC ground at the Vref node. This embodiment serves a similar purpose as the example shown in FIG. 2, which is to achieve signal attenuation while preventing DC current flow through the attenuation resistors, which adds to the power consumption of the microphone.

It will be understood that the number and values of resistors included in bank 1225 may vary depending on the needs of the designer, and that the buffer 1222 may not be necessary in all designs, depending on the following circuitry and the needs of the designer.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microphone, comprising:
a microelectromechanical system (MEMS) device, the MEMS device converting acoustic energy into electrical signals;
an amplifier coupled to the MEMS device, the amplifier receiving an input signal from the MEMS device and performing amplification on the input signal to produce an output signal;
an attenuation apparatus coupled the amplifier, wherein activation of the attenuation apparatus is effective to attenuate the output signal of the amplifier;
wherein a self-noise of the amplifier is attenuated and a sensitivity of the microphone is reduced such that a first signal-to-noise ratio is substantially the same as a second signal-to-noise ratio, the first signal-to-noise ratio occurring when the attenuation apparatus is not activated, and the second signal-to-noise ratio occurring when the attenuation apparatus is activated.

2. The microphone of claim 1, wherein the attenuation apparatus comprises a plurality of resistors that are selectively utilized in the attenuation apparatus.

3. The microphone of claim 1, wherein the attenuation apparatus comprises a plurality of resistors and at least one capacitor that are selectively utilized in the attenuation apparatus.

4. The microphone of claim 1, wherein the attenuation apparatus comprises at least one capacitor that is coupled to the output of the amplifier.

5. The microphone of claim 4, wherein the attenuation apparatus further comprises a plurality of resistors that are selectively utilized by the attenuation apparatus.

6. The microphone of claim 1, wherein the attenuation apparatus comprises an active attenuation circuit that is selectively utilized by the attenuation apparatus.

7. The microphone of claim 1, further comprising a second attenuation apparatus coupled to an input of the amplifier.

8. The microphone of claim 1, wherein the attenuation apparatus comprises one or more of a capacitor, a resistor, and an operational amplifier.

9. The microphone of claim 1, wherein the attenuation apparatus comprises a plurality of capacitors that are selectively utilized by the attenuation apparatus.
